(19) United States
(12) Patent Application Publication
(10) Pub. No.: US 2015/0363744 A1
(43) Pub. Date: Dec. 17, 2015

(54) TRACKING CHANGES IN RESUMES TO IDENTIFY PERSONS INTERESTED IN ACQUIRING A NEW POSITION

(71) Applicant: INTERNATIONAL BUSINESS MACHINES CORPORATION, Armonk, NY (US)

(72) Inventors: Casey Dugan, Cambridge, MA (US); Werner Geyer, Newton, MA (US); Tak Yeon Lee, Glenn Dale, MD (US); Tristan Ratchford, Boston, MA (US); Todd Steven Soule, Cambridge, MA (US)

(21) Appl. No.: 14/305,296

(22) Filed: Jun. 16, 2014

(51) Int. Cl. G06Q 10/10; G06F 17/30

(52) U.S. Cl. CPC G06Q 10/1053; G06F 17/30867

(57) ABSTRACT

A method, system, and computer program product for identifying persons who may be interested in acquiring a new position by tracking changes in their resumes. The present invention provides an efficient method to both prevent employee attrition and to signal to potential future employers that the person may become available soon. In general, the invention works by crawling a resume source for resumes, determining the resume owner, associating owner contact information, and tracking changes made to the resumes. If a resume is changed within a certain time period above a certain threshold activity level, then the resume owner is identified as being interested in acquiring a new position. Multiple different resumes from multiple different resume sources can also be mapped to a single owner to provide an aggregate actual resume in which changes can be tracked and used to identify employees interested in acquiring a new position.

### BACKGROUND

The present invention relates to the field of workforce analytics. More specifically, to a method, system, and computer program product for identifying persons who may be interested in acquiring a new position (e.g. a new job).

Identifying people who are thinking about or planning to change positions is useful because it can help the person's current employer prevent employee attrition and because it can signal to potential future employers that the person may become available soon.

A common method used to detect employee attrition risk is through analyzing employee responses to detailed employee engagement surveys. The problem with this method, and those similar to it, is that these methods depend on the employees to provide the information and assume that the employees will truthfully answer the questions that assess their risk. Another problem is that these methods can only be performed sporadically (usually on an annual basis) because they are expensive and time consuming.

Resumes are traditionally the main initial means of communication between prospective hiring parties and job applicants. Although the technology surrounding the writing and dissemination of resumes has advanced (going from written paper and hand delivery to computer generated and posted on job recruiting websites), resumes still remain a key factor in determining potential qualified employees. Job applicants use resumes to highlight their most important experiences, achievements, and education. When a person is considering obtaining or changing employment, updating and making changes to their resume is often the first step.

The advent of the Internet has revolutionized the job searching process. Job seekers now have a plethora of recruiting websites, forums, and forms (e.g., text document, PDFs, videos) to choose from and upload their resumes. The problem with having so many options is job seekers often times post their resumes on numerous different websites, in different forms, and/or at different times in life. At different stages one website might host the job seeker's current resume with the most up-to-date information, only to be abandoned and become outdated when the job seeker later chooses another website and/or form to post their most up-to-date resume. This makes it virtually impossible for employers, themselves, to keep up with and track specific job seekers resumes and the changes across all the websites, forums, and/or forms across the Internet. Today, the World Wide Web (WWW or simply Web) contains more than one billion pages. The size and continuous explosive growth of the Web has created a need for tools and methods that can automatically access, search, index, extract, and recombine information that is available on the Web.

A common method used by Human Resource (HR) professionals to find and recruit potential employees is to browse resumes on employment networking/recruiting websites. Examples of these websites include LinkedIn.com, Monster.com, and CareerBuilder.com. The problem with this method is that the HR professionals can only identify potential employees through explicit signals, such as the user stating that he/she is looking for a new job. These HR professionals are not able to efficiently browse all the avenues of the Internet where potential employees post their resumes and compare these resumes in order to identify implicit signals that the potential employee may be interested in acquiring a new job.

Therefore, in light of the aforementioned problems and the fact that resumes play a key role in identifying a person who is interested in acquiring a new position, there is a great need for a more efficient and automatic method for identifying persons who may be interested in acquiring a new position through implicit signals.

### SUMMARY

Accordingly, one aspect of the present invention is a computer-implemented method for detecting changes to a resume to identify persons who are interested in acquiring a new position, the method including: crawling a resume source for a plurality of electronic documents, wherein the resume source is stored on a computerized device; classifying at least one of the electronic documents as a first iteration of the resume based on a first set of features of the electronic document; storing an original source location of the first iteration of the resume; determining a resume owner for the resume based on a second set of features of the electronic document; refetching a second iteration of the resume from the original source location; detecting any differences between the first and second iterations of the resume; storing the differences in a change history; analyzing the change history; and identifying, based on the analysis of the change history, whether the resume owner is interested in acquiring a new position.

Another aspect of the present invention is a resume monitoring system for detecting changes to a resume to identify employees who are interested in acquiring a new job, the resume monitoring system including: a memory; a processor communicatively coupled to the memory; and a resume monitoring module coupled to the memory and the processor, wherein the resume monitoring module is configured to perform the method including: crawling a resume source for a plurality of electronic documents; classifying at least one of the electronic documents as a first iteration of the resume based on a first set of features of the electronic document; storing an original source location of the first iteration of the resume; determining a resume owner for the resume based on a second set of features of the electronic document; refetching a second iteration of the resume from the original source location; detecting any differences between the first and second iterations of the resume; storing the differences in a change history; analyzing the change history; and identifying, based on the analysis of the change history, whether the resume owner is interested in acquiring a new position.

Another aspect of the present invention is a computer program product for detecting changes to a resume to identify persons who are interested in acquiring a new position, the computer program product including a computer readable storage medium having program instructions embodied therewith, wherein the computer readable storage medium is not a transitory signal per se, the program instructions readable/executable by a computer device to cause the computer device to perform a method including: crawling a resume source for a plurality of electronic documents; classifying at least one of the electronic documents as a first iteration of the resume based on a first set of features of the electronic document; storing an original source location of the first iteration of the resume; determining a resume owner for the resume based on a second set of features of the electronic document; refetching a second iteration of the resume from the original source location; detecting any differences between the first and second iterations of the resume; storing the differences in a change history; analyzing the change history; and identifying, based on the analysis of the change history, whether the resume owner is interested in acquiring a new position.

An advantage of the present invention is that it automatically identifies and tracks a person's resume to identify through implicit signals whether this person may be interested in acquiring a new position.

### BRIEF DESCRIPTION OF THE SEVERAL VIEWS OF THE DRAWINGS

The subject matter which is regarded as the invention is particularly pointed out and distinctly claimed in the Claims at the conclusion of the specification. The foregoing and other objects, features, and advantages of the present invention are made apparent through the following detailed description taken in conjunction with the accompanying drawings.

FIG. 1 is a block diagram illustrating an embodiment of the hardware components of a computing system/device according to an embodiment of the present invention.

FIG. 2 is a flowchart of the method for detecting changes to resumes to identify persons who may be interested in acquiring a new position according to an embodiment of the present invention.

FIG. 3 is a block diagram of a resume monitoring apparatus according to an embodiment of the present invention. The parts contained in the broken lines are optional according to various embodiments of the present invention.

FIG. 4 is a flowchart of the method for detecting changes to resumes to identify persons who may be interested in acquiring a new position according to another embodiment of the present invention.

### DETAILED DESCRIPTION

The present invention relates to the field of workforce analytics. More specifically, to a method, system, and computer program product for identifying persons who may be interested in acquiring a new position (e.g., a new job). The present invention provides an efficient and automatic method for identifying persons who may be interested in acquiring a new position by tracking changes in their resume (implicit signals). In general, the present invention works by crawling a resume source for resumes, determining the owner of each resume, associating contact information with the owner, and tracking changes made to the resumes. If a resume for a given owner has been changed within a certain time period above a certain threshold activity level, then the resume owner is identified as being interested in acquiring a new position.

Some preferable embodiments are described below in more detail with reference to the accompanying drawings, in which the preferable embodiments of the present invention have been illustrated. However, the present invention can be implemented in various manners and, thus, cannot be construed to be limited to the embodiments disclosed herein. On the contrary, these embodiments of the present invention are provided for the thorough and complete understanding of the present invention and for completely conveying the scope of the present invention to those skilled in the art. The same reference generally refers to the same components in the exemplary embodiments of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

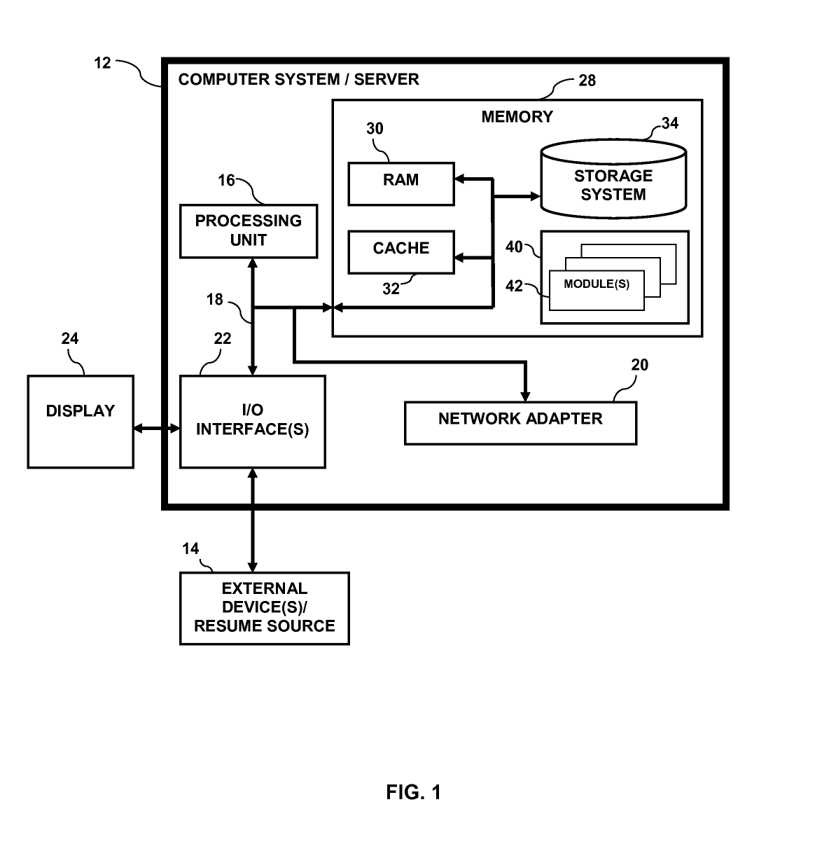

Referring to FIG. 1, FIG. 1 is a block diagram of an exemplary computer system/server 12 in detail, which is applicable to implement the embodiments of the present invention. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media can be any available media that is accessible by computer system/server 12 and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”) and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 (such as a keyboard, a pointing device, a display 24, etc.), one or more devices that enable a user to interact with computer system/server 12, and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to, microcode, device drivers, redundant processing units, external disk drive arrays, RAID systems, tape drives, and data archival storage systems, etc.

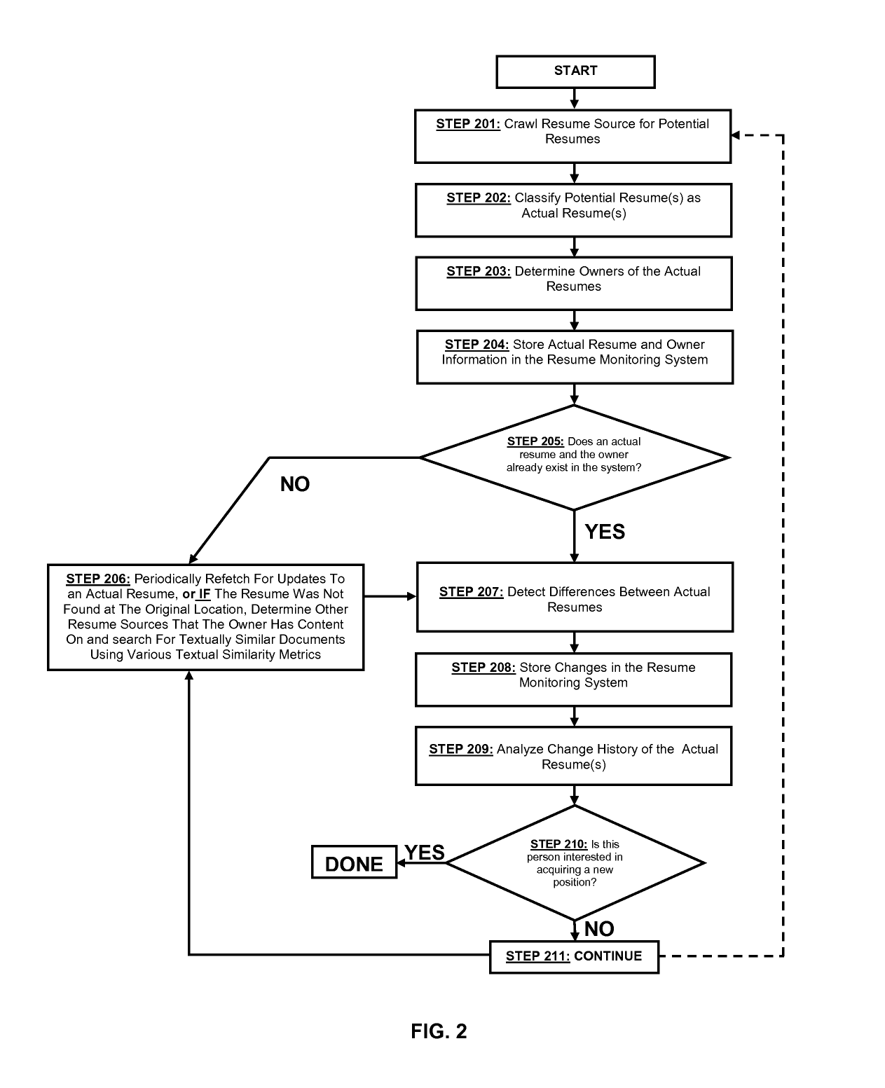

In the following detailed description, a resume monitoring method according to an embodiment of the present invention is described with reference to FIG. 2. FIG. 2 is a flowchart of the method for detecting changes to resumes to identify persons (users, people, current employees, potential future employees, employees, resume owners, etc.) who may be interested in acquiring a new position according to an embodiment of the present invention.

As shown in FIG. 2, in step 201, crawling a resume source for potential resumes. A crawler is a program that systematically browses a resume source. The use of crawlers is known in the prior art, therefore the detailed explanation is omitted here. A resume source includes, but is not limited to, the Internet, specific websites (for example a professional networking website such as LinkedIn.com or Monster.com), personal websites, university student directories, network file storage systems, cloud storage systems (e.g., connections or dropbox), file version control systems (e.g., SVN, CVS, Git), and/or internal and external electronic resume databases or servers. A potential resume is any electronic document that provides information that may contain resume-type information and features. Therefore, in step 201, a resume source is crawled for potential resumes.

In step 202, classifying potential resumes as actual resumes. A potential resume is classified as an actual resume if it contains one or more of the following features:
1. If the potential resume contains explicit textual indicators (e.g., “resume,” “curriculum vitae,” and/or “CV”) located in the document, in the URL to the document, in the linked text to the document, and/or in artifacts surrounding the document. An example is an employee posting a message to a message board that states “here is a link to my resume.” The document contained in the link will be classified as an actual resume;
2. If the potential resume does not explicitly state that it is a resume, but contains common resume section headings, such as objectives, education, honors and awards, skills, volunteer experience, work experience, publications, etc;
3. If the potential resume is located in a resume source specifically identified (or stated) to contain resume content. For example, LinkedIn.com can be specifically identified as a resume source in which each profile page is an actual resume. Therefore, each profile page (document) found on the website is classified as an actual resume; and/or
4. If prior knowledge is inputted into the resume monitoring system that states that the potential resume (document) is an actual resume. In other words, an affirmative statement or action transmitted with the document stating that the document is a resume. For example, an email in which the subject heading states “this is my resume” and it contains a PDF inside. The PDF will be classified as an actual resume.
   Those skilled in the art can determine other features that can be used to determine whether a document (potential resume) is classified as an actual resume that do not depart from the scope of the present invention.

In step 203, determining the owners of the actual resumes. The owner (resume owner) of the actual resume is determined by one or more of the following features:
1. A name, address, e-mail address, Internet service username (e.g., Twitter account name), and/or telephone number contained within the actual resume;
2. The owner of the web page or profile page where the actual resume was located;
3. A name, address, e-mail address, Internet service username (e.g., Twitter account name), and/or telephone number contained in artifacts surrounding the actual resume on the same website. For example, if the homepage of JLBaking.com states that John Smith is the owner of the website and an actual resume is found under a tab titled “RESUME,” then John Smith the owner of the website is identified as the owner of the actual resume; and/or
4. Prior knowledge is inputted into the resume monitoring system that identifies (states) the owner of the actual resume. In other words, an affirmative statement is made or an action is performed that identifies the owner of the actual resume. For example, John Smith inputs into the system that he is the owner of a specific actual resume.
   Those skilled in the art can determine other features that can be used to identify the owner of the actual resume that do not depart from the scope of the present invention.

In step 204, storing the actual resume information and owner information into the resume monitoring system. In step 205, determining whether the owner already exists in the system and whether an actual resume already exists for that owner. If there is no other actual resume in the system for that owner, the method continues to step 206. If the owner and an actual resume do already exist in the system, the method proceeds directly to step 207.

In step 206, refetching for updates to an actual resume. This means periodically or continuously checking the original location where the actual resume was located and recording an iteration of the actual resume. Note that each time an actual resume is re-fetched, each iteration of the actual resume is time stamped and recorded as a different version of the actual resume. Then the resume monitoring method proceeds to step 207.

In step 207, detecting differences between iterations of the actual resume. The iterations of the actual resume are ordered by creation date (time stamp) and textual and structural differences between iterations of the resume are calculated. Textual differences include, but are not limited to, adding, removing, and/or editing the text of the document. Structural differences include, but are not limited to, formatting and organizational changes to the document. In step 208, storing these differences in the resume monitoring system. If there are not any detected differences between iterations of the actual resume, this information is also stored in the resume monitoring system.

In another embodiment of the present invention, step 206 can also include: if the actual resume was not found at the original location, determining other locations in the same resume source (for example, other profile pages) or in other resume sources (for example, other websites) where the actual resume is located. This can include determining other websites that the owner has content on and searching for textually similar documents using various textual similarity metrics. Note that in this embodiment of the present invention, the time stamp can be adjusted to reflect the time and date that the actual resume was created. For example, a word document or PDF file may contain metadata that indicates the time and date that the word document or PDF file was created. This information can be used to determine which version of the actual resume was created earlier in time so that the various actual resumes and their subsequent recorded iterations can be ordered properly in order to detect the differences between iterations in step 207.

In step 209, analyzing a change history of the iterations of the actual resume. In step 210, identifying if this resume owner is interested in acquiring a new position based on the analysis of the change history. If the resume owner is identified as a person interested in acquiring a new position, the method is complete. If the resume owner is not identified as being interested in acquiring a new position, the method proceeds to step 211. In this embodiment of the present invention, in step 211, the method proceeds back to step 206.

An owner is identified as being interested in acquiring a new position based on an attrition risk analytic score. This attrition risk analytic score can be based solely on, for example and not limited to, the amount of activity being above a certain threshold, on the relative amount of activity for a specific owner being above a certain threshold activity level for that owner, and/or on the specific type of changes made to the actual resume. The higher the attrition risk analytic score, the more likely it is that the person is interested in acquiring a new position. The attrition risk analytic score allows a current employer to determine and present financial and/or other incentives to employees who present a high attrition risk in order to entice them to stay. The attrition risk analytic score also allows interested potential future employers to determine if they would like to make offers to employees who present a high attrition risk in order to entice them to join their company.

In another embodiment of the present invention, multiple different actual resumes from multiple different resume sources can be mapped to a single owner and provide an aggregate actual resume (or profile) in which changes can be tracked using this aggregate information to identify persons who may be interested in acquiring a new position. In this case, after step 210, if the owner is not identified as being interested in acquiring a new position, the method can proceed to step 211. In this embodiment of the present invention, in step 211 the method continues to step 206 (refetching for updates to an actual resume) and also to step 201 (refer to the dashed line in FIG. 1) in which the method continues to crawl the multiple different resume sources for potential resumes and repeats steps 201-210.

In another embodiment of the present invention, multiple different actual resumes from multiple different resume sources can be mapped to a single owner. Each actual resume is time stamped with a creation date and then ordered by creation date. Resume changes can be tracked across these ordered actual resumes (including their respective recorded iterations) to identify persons who may be interested in acquiring a new position. Note that in this embodiment of the present invention, the time stamp can be adjusted to reflect the time and date that the actual resume was created. For example, a word document or PDF file may contain metadata that indicates the time and date that the word document or PDF file was created. This information can be used to determine which version of the actual resume was created earlier in time so that the various actual resumes and their subsequent recorded iterations can be ordered properly. In this embodiment of the present invention, in step 211 the method continues to step 206 (refetching for updates to an actual resume) and also to step 201 (refer to the dashed line in FIG. 1) in which the method continues to crawl the multiple different resume sources for potential resumes and repeats steps 201-210.

Further, in another embodiment of the present invention, the resume monitoring method can provide a mechanism to use the aggregate actual resume information to signal a confidence score that indicates the confidence level that a person is indeed looking to acquire a new position.

In another embodiment of the present invention, the resume monitoring method can provide a mechanism to order or rank the resume owners by: the highest overall activity level; and/or a higher than usual activity level based on a threshold activity level for that owner.

In another embodiment of the present invention, the resume monitoring method can provide a mechanism to filter resume owners by various attributes contained in the actual resume, such as by location, present or previous employment, skills, education, etc.

In another embodiment of the present invention, the resume monitoring method can provide a mechanism for a person to: manually remove documents from the resume monitoring system that are not actual resumes or that the person does not want available; manually upload actual resumes; and/or manually correct or augment information about an actual resume (e.g., correct owner information or location the actual resume was fetched).

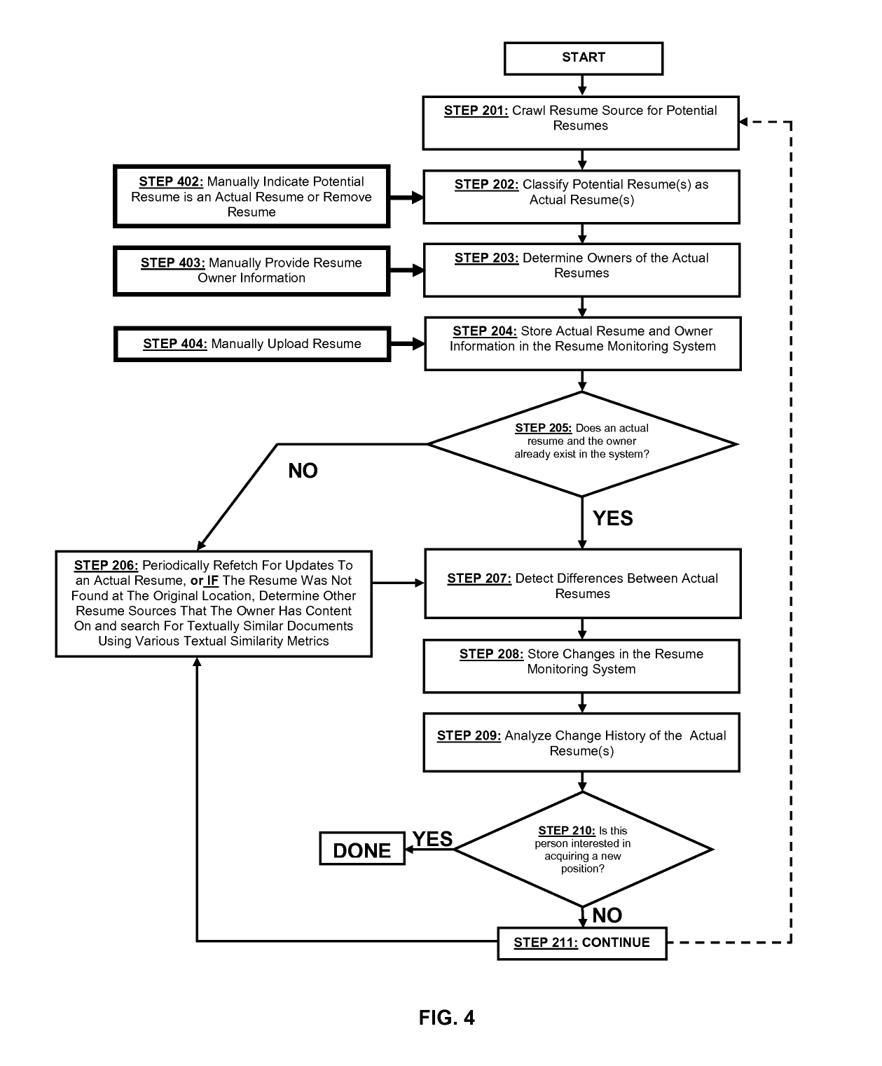

Referring to FIG. 4, FIG is a flowchart of the method for detecting changes to resumes to identify persons who may be interested in acquiring a new position according to another embodiment of the present invention. More specifically, FIG. 4 shows: step 402, manually indicating that a document is an actual resume or removing a document or resume; step 403, manually providing resume owner information; and step 404, manually uploading a resume.

In another embodiment of the present invention, the resume monitoring method can also be used to identify persons who may be interested in acquiring a new position within the same organization. For example, an employee interested in changing positions within an organization might update their skills on the organization's internal employee database. The present invention can track these changes in order to identify persons who may be interested in acquiring a new position within the same organization.

In another embodiment of the present invention, the resume monitoring method can also be used to identify persons who may be interested in returning to school. For example, a person interested in returning to school might update their resume to include GPA and test score information. The present invention can track these changes in order to identify persons who may be interested in acquiring a new position as a student.

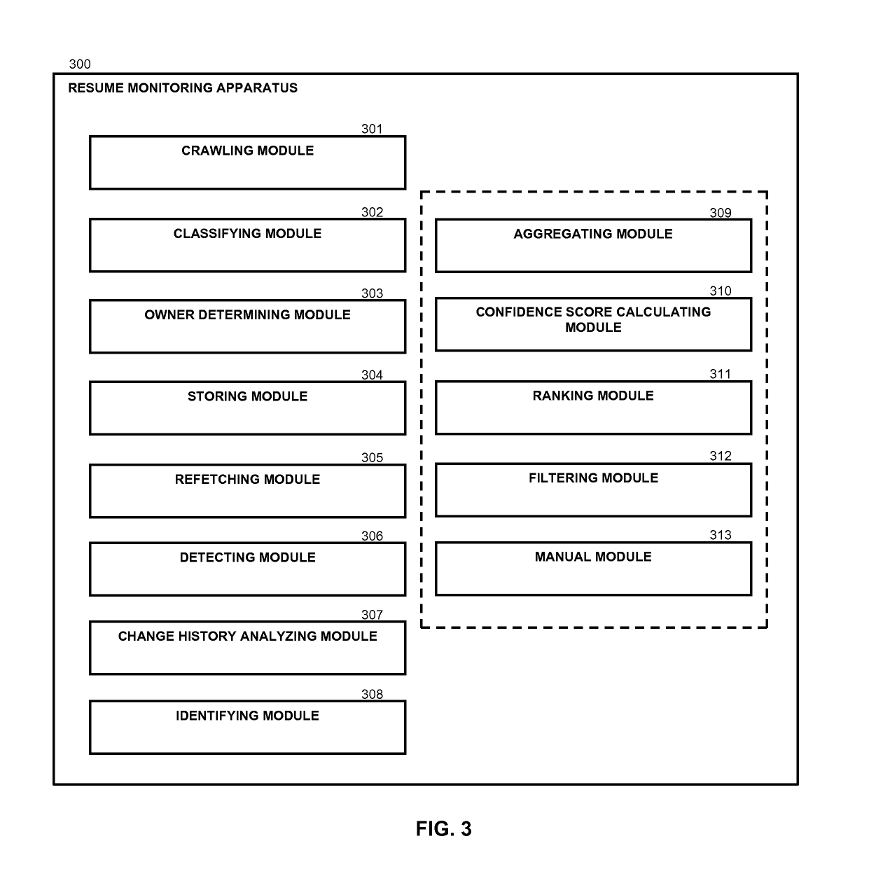

Next, a resume monitoring apparatus (system) 300 according to an embodiment of the present invention is described with reference to FIG. 3. This apparatus can execute the resume monitoring method described above with reference to FIG. 2. As shown in FIG. 3, the resume monitoring apparatus 300 can include the following parts. A crawling module 301 configured to crawl a resume source for potential resumes; a classifying module 302 configured to classify potential resumes as actual resumes, wherein the classifying module classifies the potential resume as an actual resume according to one or more of the following features:
1. If the potential resume contains explicit textual indicators located in the document, in the URL to the document, in the linked text to the document, and/or in artifacts surrounding the document;
2. If the potential resume does not explicitly state that it is a resume, but contains common resume section headings (such as objectives, education, honors and awards, skills, volunteer experience, work experience, publications, etc.);
3. If the potential resume is located in a resume source specifically identified (stated) to contain resume content; and/or
4. If prior knowledge is inputted into the resume monitoring system that states that the potential resume (document) is an actual resume;
   an owner determining module 303 configured to determine the owners of the actual resumes, wherein the owner determining module determines the owner (resume owner) according to one or more of the following features:
1. A name, address, e-mail address, Internet service username (e.g., Twitter account name), and/or telephone number contained within the actual resume;
2. The owner of the web page or profile page where the actual resume was located;
3. A name, address, e-mail address, Internet service username (e.g., Twitter account name), and/or telephone number contained in artifacts surrounding the resume on the same website; and/or
4. Prior knowledge is inputted into the resume monitoring system that identifies the owner of the actual resume;
   a storing module 304 configured to store the actual resume information (including resume location), owner information, and textual and structural differences between iterations of the actual resume into a resume monitoring system; a refetching module 305 configured to refetch for updates to an actual resume by periodically or continuously checking the original location where the actual resume was located and recording an iteration of the actual resume and time stamping the iteration of the actual resume; a detecting module 306 configured to order iterations of the actual resume by creation date (time stamp) and detect textual and structural differences between iterations of the actual resume; a change history analyzing module 307 configured to analyze a change history of the iterations of the actual resume; and an identifying module 308 configured to identity if the resume owner is interested in acquiring a new position, wherein the identifying module is further configured to calculate an attrition risk analytic score based on the analysis of the change history.

In another embodiment of the present invention, the refetching module of the resume monitoring apparatus can further be configured to determine other resume sources where the actual resume is located.

In another embodiment of the present invention, the resume monitoring apparatus includes an aggregating module 309 configured to aggregate multiple different actual resumes from multiple different resume sources and provide an aggregate actual resume that can be mapped to a single owner.

Further, in another embodiment of the present invention, the resume monitoring apparatus includes a confidence score calculating module 310 configured to calculate a confidence score that indicates the confidence level that a person is indeed looking to acquire a new position.

In another embodiment of the present invention, the resume monitoring apparatus includes a ranking module 311 configured to order or rank the resume owners by: the highest overall activity level; and/or higher than usual activity level based on a threshold activity level for that owner.

In another embodiment of the present invention, the resume monitoring apparatus includes a filtering module 312 configured to filter resume owners by various attributes contained in the actual resume, such as by location, present or previous employment, skills, education, etc.

In another embodiment of the present invention, the resume monitoring apparatus includes a manual module 313 configured to: allow the manual removal of documents from the resume monitoring system; allow the manual uploading of documents to the resume monitoring system; and allow a user to manually correct or augment information about an actual resume (refer to FIG. 4).

In another embodiment of the present invention, the resume monitoring apparatus can also be configured to identify persons who may be interested in acquiring a new position within the same organization.

In another embodiment of the present invention, the resume monitoring apparatus can also be configured to identify persons who may be interested in returning to school.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for detecting changes to a resume to identify persons who are interested in acquiring a new position, the method comprising:
crawling a resume source for a plurality of electronic documents, wherein said resume source is stored on a computerized device;
classifying at least one of said electronic documents as a first iteration of said resume based on a first set of features of said electronic document;
storing an original source location of said first iteration of said resume;
determining a resume owner for said resume based on a second set of features of said electronic document;
refetching a second iteration of said resume from said original source location;
detecting any differences between said first and second iterations of said resume;
storing said differences in a change history;
analyzing said change history; and
identifying, based on said analysis of said change history, whether said resume owner is interested in acquiring a new position.

2. The computer-implemented method according to claim 1, wherein said first set of features comprises one or more of the following features:
said electronic document contains explicit textual indicators located in the group consisting of: said electronic document, a URL to said electronic document, a linked text to said electronic document, and in artifacts surrounding said electronic document;
said electronic document contains a plurality of common resume section headers;
said electronic document is located in said resume source specifically identified to contain resume content; and
said electronic document is stated to be said first iteration of said resume.

3. The computer-implemented method according to claim 1, wherein said second set of features comprises one or more of the following features:
a name, address, e-mail address, Internet service username, and/or telephone number contained in said resume;
said person is the owner of a web page or a profile page where said resume is located;
a name, address, e-mail address, Internet service username, and/or telephone number contained in artifacts surrounding said resume; and
said person is stated to be said resume owner.

4. The computer-implemented method according to claim 1, wherein the step of identifying, based on said analysis of said change history, whether said resume owner is interested in acquiring a new position further comprises:
calculating an attrition risk analytic score, wherein said attrition risk analytic score is calculated based on one of:
said resume owner having an activity level above a threshold activity level;
said resume owner having said activity level above a relative activity threshold for said resume owner; and
said resume owner making a specific change to said resume.

5. The computer-implemented method according to claim 4, wherein if said resume owner is not identified as interested in acquiring a new position, the method further comprising:
refetching a third iteration of said resume from said original source location;
detecting any differences between said iterations of said resume;
storing said differences in said change history;
analyzing said change history; and
identifying, based on said analysis of said change history, whether said resume owner is interested in acquiring said new position.

6. The computer-implemented method according to claim 5, wherein if said resume is not found at said original source location, the method further comprising:
determining a next location where said resume is located.

7. The computer-implemented method according to claim 4, wherein a plurality of resumes from a plurality of resume sources is mapped to said resume owner to provide an aggregate resume; and
wherein said change history of said aggregate resume is analyzed to identify whether said resume owner is interested in acquiring a new position.

8. The computer-implemented method according to claim 4, wherein a plurality of resumes from a plurality of resume sources is mapped to said resume owner.

9. A computer program product for detecting changes to a resume to identify persons who are interested in acquiring a new position, the computer program product comprising a computer readable storage medium having program instructions embodied therewith, wherein the computer readable storage medium is not a transitory signal per se, the program instructions readable/executable by a computer device to cause the computer device to perform the method according to claim 1.

10. A resume monitoring system for detecting changes to a resume to identify employees who are interested in acquiring a new job, the resume monitoring system comprising:
a memory;
a processor communicatively coupled to the memory; and
a resume monitoring module coupled to the memory and the processor, wherein the resume monitoring module is configured to perform the method comprising:
crawling a resume source for a plurality of electronic documents;
classifying at least one of said electronic documents as a first iteration of said resume based on a first set of features of said electronic document;
storing an original source location of said first iteration of said resume;
determining a resume owner for said resume based on a second set of features of said electronic document;
refetching a second iteration of said resume from said original source location;
detecting any differences between said first and second iterations of said resume;
storing said differences in a change history;
analyzing said change history; and
identifying, based on said analysis of said change history, whether said resume owner is interested in acquiring a new position.

11. The resume monitoring system according to claim 10, wherein said first set of features comprises one or more of the following features:
said electronic document contains explicit textual indicators located in the group consisting of: said electronic document, a URL to said electronic document, a linked text to said electronic document, and in artifacts surrounding said electronic document;
said electronic document contains a plurality of common resume section headers;
said electronic document is located in said resume source specifically identified to contain resume content; and
said electronic document is stated to be said first iteration of said resume.

12. The resume monitoring system according to claim 10, wherein said second set of features comprises one or more of the following features:
a name, address, e-mail address, Internet service username, and/or telephone number contained in said resume;
said person is the owner of a web page or a profile page where said resume is located;
a name, address, e-mail address, Internet service username, and/or telephone number contained in artifacts surrounding said resume; and
said person is stated to be said resume owner.

13. The resume monitoring system according to claim 10, wherein the step of identifying, based on said analysis of said change history, whether said resume owner is interested in acquiring a new position further comprises:
calculating an attrition risk analytic score, wherein said attrition risk analytic score is calculated based on one of:
said resume owner having an activity level above a threshold activity level;
said resume owner having said activity level above a relative activity threshold for said resume owner; and
said resume owner making a specific change to said resume.

14. The resume monitoring system according to claim 13, wherein if said resume owner is not identified as interested in acquiring a new position, the method further comprising:
refetching a third iteration of said resume from said original source location;
detecting any differences between said iterations of said resume;
storing said differences in said change history;
analyzing said change history; and
identifying, based on said analysis of said change history, whether said resume owner is interested in acquiring said new position.

15. The resume monitoring system according to claim 14, wherein if said resume is not found at said original source location, the method further comprising:
determining a next location where said resume is located.

16. The resume monitoring system according to claim 13, wherein a plurality of resumes from a plurality of resume sources is mapped to said resume owner to provide an aggregate resume; and
wherein said change history of said aggregate resume is analyzed to identify whether said resume owner is interested in acquiring a new position.

17. The resume monitoring system according to claim 13, wherein a plurality of resumes from a plurality of resume sources is mapped to said resume owner.

18. A computer program product for detecting changes to a resume to identify persons who are interested in acquiring a new position, the computer program product comprising a computer readable storage medium having program instructions embodied therewith, wherein the computer readable storage medium is not a transitory signal per se, the program instructions readable/executable by a computer device to cause the computer device to perform a method comprising:
crawling a resume source for a plurality of electronic documents;
classifying at least one of said electronic documents as a first iteration of said resume based on a first set of features of said electronic document;
storing an original source location of said first iteration of said resume;
determining a resume owner for said resume based on a second set of features of said electronic document;
refetching a second iteration of said resume from said original source location;
detecting any differences between said first and second iterations of said resume;
storing said differences in a change history;
analyzing said change history; and
identifying, based on said analysis of said change history, whether said resume owner is interested in acquiring a new position.

19. The computer program product according to claim 18, wherein said first set of features comprises one or more of the following features:
said electronic document contains explicit textual indicators located in the group consisting of: said electronic document, a URL to said electronic document, a linked text to said electronic document, and in artifacts surrounding said electronic document;
said electronic document contains a plurality of common resume section headers;
said electronic document is located in said resume source specifically identified to contain resume content; and
said electronic document is stated to be said first iteration of said resume.

20. The computer program product according to claim 18, wherein said second set of features comprises one or more of the following features:
a name, address, e-mail address, Internet service username, and/or telephone number contained in said resume;
said person is the owner of a web page or a profile page where said resume is located;
a name, address, e-mail address, Internet service username, and/or telephone number contained in artifacts surrounding said resume; and
said person is stated to be said resume owner.

21. The computer program product according to claim 18, wherein the step of identifying, based on said analysis of said change history, whether said resume owner is interested in acquiring a new position further comprises:
calculating an attrition risk analytic score, wherein said attrition risk analytic score is calculated based on one of:
said resume owner having an activity level above a threshold activity level;
said resume owner having said activity level above a relative activity threshold for said resume owner; and
said resume owner making a specific change to said resume.

22. The computer program product according to claim 21, wherein if said resume owner is not identified as interested in acquiring a new position, the method further comprising:
refetching a third iteration of said resume from said original source location;
detecting any differences between said iterations of said resume;
storing said differences in said change history;
analyzing said change history; and
identifying, based on said analysis of said change history, whether said resume owner is interested in acquiring said new position.

23. The computer program product according to claim 22, wherein if said resume is not found at said original source location, the method further comprising:
determining a next location where said resume is located.

24. The computer program product according to claim 21, wherein a plurality of resumes from a plurality of resume sources is mapped to said resume owner to provide an aggregate resume; and
wherein said change history of said aggregate resume is analyzed to identify whether said resume owner is interested in acquiring a new position.

25. The computer program product according to claim 21, wherein a plurality of resumes from a plurality of resume sources is mapped to said resume owner.
